(19) United States
(12) Patent Application Publication
(10) Pub. No.: US 2006/0266700 A1
(43) Pub. Date: Nov. 30, 2006

(54) Porous structures with engineered wettability properties and methods of making them

(75) Inventors: Anthony Yu-Chung Ku, Rexford, NY (US); Sergio Paulo Martins Loureiro, Saratoga Springs, NY (US); James Anthony Ruud, Delmar, NY (US); Mohan Manoharan, Niskayuna, NY (US); Lawrence Bernard Kool, Clifton Park, NY (US); Seth Thomas Taylor, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/141,576

(22) Filed: May 31, 2005

(51) Int. Cl. B01D 71/00

(52) U.S. Cl. 210/500.21; 210/500.27; 210/506; 427/245

(57) ABSTRACT

A porous structure and method of making the porous structure is disclosed. The porous structure includes a substrate comprising at least one pore having an internal surface. At least a first portion of the internal surface of the at least one pore has a first fluid contact angle and at least second portion of the internal surface of the at least one pore has a second fluid contact angle. The difference between the first fluid contact angle and the second fluid contact angle has an absolute value of at least about 5 degrees and the second fluid contact angle is greater than about 40 degrees.

### BACKGROUND OF THE INVENTION

The invention relates to porous structures. Particularly, the invention relates to porous structures having engineered wettability properties.

### Description of the Related Art

Known porous structures, such as membranes, typically exhibit a single, uniform wettability characteristic for a given fluid or if different wettability characteristics are provide to the porous structure, the differences among them are minor. Furthermore, existing porous structures typically contain pores with internal surfaces that are uniformly hydrophilic or uniformly hydrophobic. Consequently, porous structures with at least two substantially different wettability characteristics for the same fluid, such as where the internal surfaces of certain pores are hydrophobic and internal surfaces of other pores are hydrophilic are still needed.

### SUMMARY OF THE INVENTION

The invention meets these and other needs by providing a porous structures with different fluid contact angles and a method of making the same.

Accordingly, one aspect of the invention provides a porous structure. The porous structure includes a substrate comprising at least one pore having an internal surface. At least a first portion of the internal surface of the at least one pore has a first fluid contact angle, and at least second portion of the internal surface of the at least one pore has a second fluid contact angle. A difference between the first fluid contact angle and the second fluid contact angle has an absolute value of at least about 5 degree, and the second fluid contact angle is greater than about 40 degrees.

A second aspect of the invention provides a method of making a porous structure. The method includes: i) providing a porous structure comprising a substrate having at least one pore with an internal surface; ii) providing at least a first portion of the internal surface of the at least one pore with a first fluid contact angle; and iii) providing at least a second portion of the internal surface of the at least one pore with a second fluid contact angle. A difference between the first fluid contact angle and the second fluid contact angle has an absolute value of at least about 5 degrees; and the second fluid contact angle is greater than about 40 degrees.

A third aspect of the invention provides a method of making a porous structure. The method includes i) providing a first porous sub-structure comprising a substrate having at least one pore with an internal surface, wherein at least a first portion of the internal surface of the at least one pore has a first fluid contact angle; and providing a second porous sub-structure comprising a substrate having at least one pore with an internal surface, wherein at least a second portion of the internal surface of the at least one pore has a second fluid contact angle; ii) combining the first porous sub-structure with the second porous sub-structure to form a porous structure with at least a first portion of the internal surface of at least one pore with a first fluid contact angle and at least a second portion of the internal surface with a second fluid contact angle. A difference between the first fluid contact angle and the second fluid contact angle has an absolute value of at least about 5 degrees; and wherein the second fluid contact angle is greater than about 40 degrees.

These and other aspects, advantages, and salient features of the present invention will become apparent from the following detailed description, the accompanying drawings, and the appended claims.

### BRIEF DESCRIPTION OF THE DRAWINGS

FIG. 1A is a cross-sectional schematic representation of a porous structure with pores having hydrophilic and hydrophobic internal surfaces in accordance with an embodiment of the invention;

FIG. 1B is a cross-sectional schematic representation of the same porous structure as in FIG. 1A showing two different fluid contact angles corresponding to pores having hydrophilic and hydrophobic internal surfaces in accordance with an embodiment of the invention;

FIG. 2 is a plan view optical micrograph of a porous structure with regions of pores having hydrophilic and hydrophobic internal surfaces in accordance with an embodiment of the invention;

FIG. 3A is another cross-sectional schematic representation of a porous structure wherein an individual pore has portions of an internal surface that are both hydrophilic and hydrophobic in accordance with an embodiment of the invention;

FIG. 3B is a cross-sectional schematic representation of the same porous structure as in FIG. 3A showing two different fluid contact angles corresponding to the pores having hydrophilic and hydrophobic internal surfaces in accordance with an embodiment of the invention;

FIG. 4 is a schematic representation of a porous structure with regions of pores having hydrophobic to hydrophilic internal surfaces in accordance with an embodiment of the invention;

FIG. 5 is a flow chart of a method of making a porous structure in accordance with an embodiment of the invention;

FIGS. 6A-B compare the electrical impedance of a porous structure with pores having hydrophilic and hydrophobic internal surfaces in accordance with an embodiment of the invention to known porous structures with pores having only hydrophobic or hydrophilic internal surfaces;

FIG. 7A is transmission electron microscopy (TEM) image of a porous structure having a first region and a second region with different wall chemical compositions in accordance with an embodiment of the invention;

FIG. 7B is an energy-filtered TEM image of the same porous structure which provides direct confirmation of the wall composition of each region; and

FIG. 8 is a schematic representation of a porous structure produced by the consolidation of nanoparticles of different composition in accordance with an embodiment of the invention.

### DETAILED DESCRIPTION

In the following description, like reference characters designate like or corresponding parts throughout the several views shown in the FIGS. It is also understood that terms such as “top,” “bottom,” “outward,” “inward,” and the like are words of convenience and are not to be construed as limiting terms.

Reference will now be made in detail to exemplary embodiments of the invention, which are illustrated in the accompanying figures and examples. Referring to the drawings in general, it will be understood that the illustrations are for the purpose of describing a particular embodiment of the invention and are not intended to limit the invention thereto.

Whenever a particular embodiment of the invention is said to comprise or consist of at least one element of a group and combinations thereof, it is understood that the embodiment may comprise or consist of any of the elements of the group, either individually or in combination with any of the other elements of that group. Furthermore, when any variable occurs more than one time in any constituent or in formula, its definition on each occurrence is independent of its definition at every other occurrence. Also, combinations of substituents and/or variables are permissible only if such combinations result in stable compounds.

The “wettability” of a solid surface is determined by observing the nature of the interaction occurring between the surface and a drop of a given fluid (i.e. liquid) disposed on the surface. A surface, such as the internal surface of a pore in a porous substrate, having a high wettability for the fluid tends to allow the drop to spread over a relatively wide area of the surface (thereby “wetting” the surface. In the extreme case, the fluid spreads into a film covering the surface. On the other hand, where the surface has a low wettability for the fluid, the fluid tends to minimize its area of contact with the surface. In the extreme case, the fluid interacts so little with the surface that the fluid appears to exhibit little to no affinity for the surface, even to the point of appearing to be repelled from the surface. Where the low-wettability surface is horizontal, the fluid will retain a highly spherical shaped droplet.

The extent to which a fluid is able to wet a solid surface plays a significant role in determining how the fluid and solid will interact with each other. A high degree of wetting results in relatively large areas of fluid-solid contact, and is desirable in applications where a considerable amount of interaction between the two surfaces is beneficial, such as, for example, adhesive and coating applications. By way of example, so-called “hydrophilic” materials have relatively high wettability in the presence of water, resulting in a high degree of “sheeting” of the water over the solid surface. Conversely, for applications requiring low solid-fluid interaction, the wettability is generally kept as low as possible in order to promote the formation of fluid drops having minimal contact area with the solid surface. “Hydrophobic” materials have relatively low water wettability; so-called “superhydrophobic” materials have even lower water wettability, resulting in surfaces that in some cases may seem to repel any water impinging on the surface due to the insignificant amount of interaction between water drops and the solid surface.

A common technique used to measure wettability of a surface is to measure its so-called “contact angle” formed between the surface and a drop of a fluid of interest. The most widely used test of contact angle involves use of a horizontal surface onto which a drop of fluid is disposed. The contact angle for this test is formed between the horizontal surface and a line tangent to the droplet at its interface with the surface. High-wettability surfaces, those surfaces upon which the fluid spreads into a sheet, thus have low contact angles while low-wettability surfaces maintain high contact angles with fluids. For instance, the term “hydrophilic” refers to surfaces forming contact angles with water of up to about 90 degrees; “hydrophobic” refers to surfaces forming contact angles with water of greater than 90 degrees. Of course, where the surface of interest is not horizontal, such as where the surface is the internal surface of a pore, the test for contact angle is less straightforward, but, as will be discussed below, techniques exist that allow contact angles to be measured for non-horizontal surfaces. Thus, the term “contact angle” as used herein should not be read to apply exclusively to horizontal surfaces. A surface herein said to have a fluid contact angle means the surface has a wettability for a given reference fluid sufficient to generate the contact angle with a droplet of the reference fluid, as measured by the technique known in the art to be appropriate for the specified geometry of the surface.

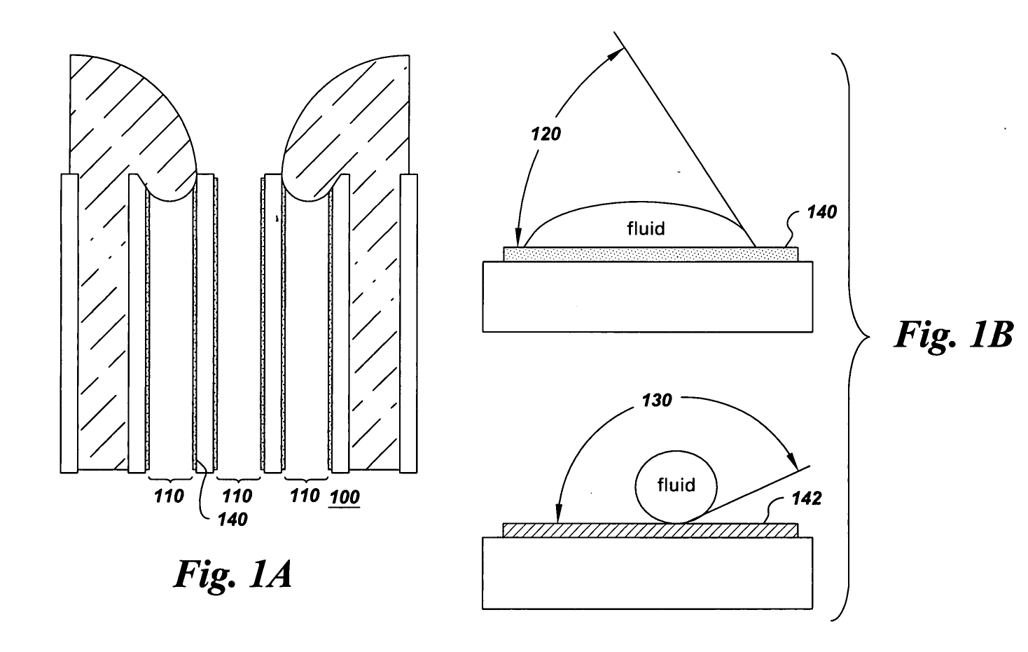

FIG. 1A is a schematic representation of a porous structure 100. Examples of a porous structure 100 include, but are not limited to, a membrane, a film, and a multilayered ceramic body.

The porous structure 100 includes a substrate comprising at least one pore 110 having an internal surface. At least a first portion of the internal surface of the at least one pore 110 has a first fluid contact angle 120. At least a second portion of the internal surface of the at least one pore 110 has a second fluid contact angle 130. The at least second portion of the pore 110 is different from the at least a first portion of the pore 110. The first fluid contact angle 120 and the second fluid contact angle 130 have a difference of an absolute value of at least about 5 degrees (i.e. at least have a difference of ±5 degrees) and the second fluid contact angle is greater than about 40 degrees.

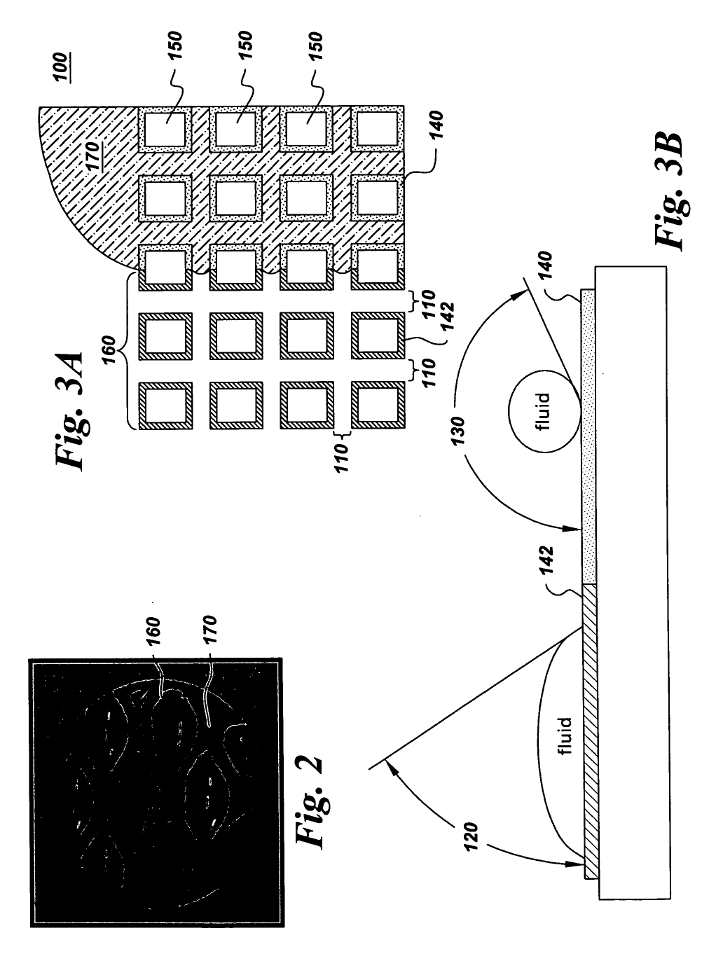

FIG. 1B is a cross-sectional schematic representation of the porous structure 100 as in FIG. 1 showing the internal surface having the first fluid contact angle 120 and the second fluid contact angle 130. In one embodiment, the difference between the first portion of the internal surface having a first fluid contact angle 120 and the second portion of the internal surface having a second fluid contact angle 130 is such that the first fluid contact angle 120 corresponds to pores 110 with hydrophilic internal surfaces and the second fluid contact angle 120 corresponds to pores 110 with hydrophobic internal surfaces. In some embodiments, the first fluid contact angle is in a range from about 0 degrees to about 90 degrees (i.e., a hydrophilic surface where the fluid comprise water), and the second fluid contact angle is in a range from about 90 degrees to about 180 degrees (i.e., a hydrophobic surface where the fluid comprises water). FIG. 2 a plan view optical micrograph of such a porous structure 100 having both hydrophilic and hydrophobic internal surfaces, wherein region 160 has a hydrophilic internal surface and region 170 has a hydrophobic internal surface.

For illustration and not limitation, one way to measure the contact angle of the internal surface of a pore 110 is the following:

Measure the capillary pressure required to pass a non-wetting reference fluid through the pore. The Laplace equation can be used to compute the effective (“flat surface”) contact angle from the known surface energy of the fluid-surface and the geometry of the pore:
del P=2*gammaLV(cos theta)/r (1)
where del P is the pressure required; gammaLV is the surface energy of the non-wetting fluid on the surface and r is the radius of the pore (assumes cylindrical pore).

If the pore geometry is known, the contact angle can be computed directly. If the pore geometry is not known, a second measurement with a wetting fluid is needed. The measurement can be of the pressure required to prevent the fluid from entering the pores. Here
del P.0=2*gamma′LV/r (2)
where del P.0=the pressure required to prevent wetting; gamma′LV is the surface energy of the wetting fluid on the surface and r is the radius of the pore.

Eliminating r from (1) and (2) gives,
cos theta=(del P*gamma′LV)/(del P.0*gammaLV) (3)

The contact angle is given now by equation 3. Reference: A. W. Adamson and A. P. Gast, Physical Chemistry of Surfaces, 6th ed. Wiley: New York, p 364 (1997).

The porous structure 100 includes one or more pores 110. Properties of each pore 110 are independent of any other pore 110. For example, the internal surface of each pore 110 may have a fluid contact angle independent of the fluid contact angle of the internal surface of another pore 110. Furthermore, the dimensions of each pore 110, including, for example, such dimensions as depth, width, length and shape, may independently vary from embodiment to embodiment and FIG. 1A depicts the pores 100 with oval or circular cross-section for illustration only.

The porous structure 100 may comprise a plurality of pores 110, (also referred to herein as “pores”). In one embodiment, each pore 110 has a pore size in a range from about 1 nm to about 2 um, and in particular embodiments, this range is from about 15 nm to about 300 nm. The term “pore size” as used herein means the largest dimension associated with the opening of the pore 110 on the surface of the structure. For example, when the pore 110 forms a circular opening on the surface of the structure, the diameter of the circle is the pore size of the pore 110. In some embodiments, the plurality of pores 110 has some pores 110 that are interconnected as in FIG. 3A. “Some pores” means any number of pores, ranging from more than one pore to all pores. In yet another embodiment, the plurality of pores 110 has some pores 110 that are not interconnected as in FIG 1a. In yet another embodiment, the plurality of pores 110 has some pores 110 that are not interconnected as well as some pores 110 that are interconnected.

As shown in FIG. 2 and FIG. 3A, the first portion of the internal surface of one or more pores 110 with a first fluid contact angle 120 may form a first region 160. Similarly, the second portion of the internal surface of one or more pores 110 with a second contact angle 130 may form a second region 170. The first region 160 and the second region 170 can be adjacent to each other or separated. Adjacent means with no space between the regions and the regions are in contact with each other. Separated means the regions are not in contact and separated by a non-treated region or another region. In one embodiment, the first region 160 and the second region 170 are disposed in a pattern, that is, in a non-random arrangement of repeating units. Examples of patterns include, but are not limited to, grid and stripes, or any other non-random arrangement. FIG. 2 is an example of a pattern.

Furthermore, as also shown in FIG. 3A, the internal surface of an individual pore 110 may have both a first contact angle 120 and a second contact angle 130 by having a first portion of the internal surface of a pore 110 with a first contact angle 120 and a second portion of the internal surface of the same pore 110 with a second contact angle 130. Furthermore, FIG. 3B is a cross-sectional schematic representation of a particular pore 110 of the same porous structure 100 as in FIG. 3A showing the two different fluid contact angles 120, 130, respectively corresponding to the hydrophilic and hydrophobic internal surfaces of the pore 110.

The porous structure 100 comprises one or more materials. Examples of materials include, but are not limited to, ceramic material, polymer or metal, either individually or in any combination thereof. In one embodiment, the material comprises a ceramic material. Examples of ceramic materials include, but are not limited to an oxide, a borate, an aluminate, a silicate, a phosphate, a nitride, a boride, and a carbide either individually or in any combination thereof. In a particular embodiment, the oxide comprises silica (SiO₂).

In one embodiment, the material comprises a polymer. In another embodiment, the material comprises a metal, particularly gold or thiol-functionalized gold. In yet another embodiment, the porous structure 100 comprises a plurality of materials. The plurality of material may comprise any combination of the materials listed above.

In one embodiment, the porous structure 100 comprises a coating 140, 142 disposed on the substrate, as shown in FIGS. 1A-1B and 3A and 3B. The porous structure 100 may comprise one type of coating in one embodiment as in FIGS. 1A-B, or in other embodiments, two or more different types of coatings, such as a first coating 140 and a second coating 142, in another embodiment, as in FIGS. 3A-b. The first coating 140 and the second coating 142 are sufficiently different to form a porous structure 100 wherein a difference between the first fluid contact angle 120 and the second fluid contact angle 130 has an absolute value of at least about 5 degrees; and wherein the second fluid contact angle is greater than about 40 degrees. In another embodiment, the porous structure 100 may comprise two different substrates, a first substrate and a second substrate. The first substrate and the second substrate are sufficiently different to form a porous structure 100 wherein a difference between the first fluid contact angle 120 and the second fluid contact angle 130 has an absolute value of at least about 5 degrees; and wherein the second fluid contact angle is greater than about 40 degrees. In yet another embodiment, the porous structure 100 may comprise two different coatings, a first coating 140 and a second coating 142, as well as two different substrates, a first substrate and a second substrate; the first substrate with the first coating 140 and the second substrate with the second coating 142 are sufficiently different to form a porous structure 100 wherein a difference between the first fluid contact angle 120 and the second fluid contact angle 130 has an absolute value of at least about 5 degrees; and wherein the second fluid contact angle is greater than about 40 degrees.

In one embodiment, any coating disposed on a substrate, such as a first coating 140 and or the second coating 142, comprises a multilayer coating 140. In some embodiment, the coating comprises an organic or inorganic molecule, either individually or in combination thereof. Examples of inorganic or organic molecules include adsorbed layers of molecules such as self-assembling monolayers, alcohols, ketones, amines, carboxylic acids, esters, amides, olefins, parrafins, acetylenes, halides, aromatics, thiols, sulfonates, metal organics, organometallics, amino acids, proteins, fatty acids, peptides, and organic natural products, either individually or in combination thereof. Examples of self-assembling monolayers include alkylchlorosilanes, alkoxysilanes, mercaptosilanes, thiols, and other self assembling monolayers that typically comprise or are formed from long chain hydrocarbons with functionality at one end such as:
CH₃(CH₂)ₙX
wherein n is an integer in a range from about 1 to about 20 and X includes, but is not limited to, all the self-assembling functionalities listed above. In a particular embodiment, n is an integer in a range from about 10 to about 20.

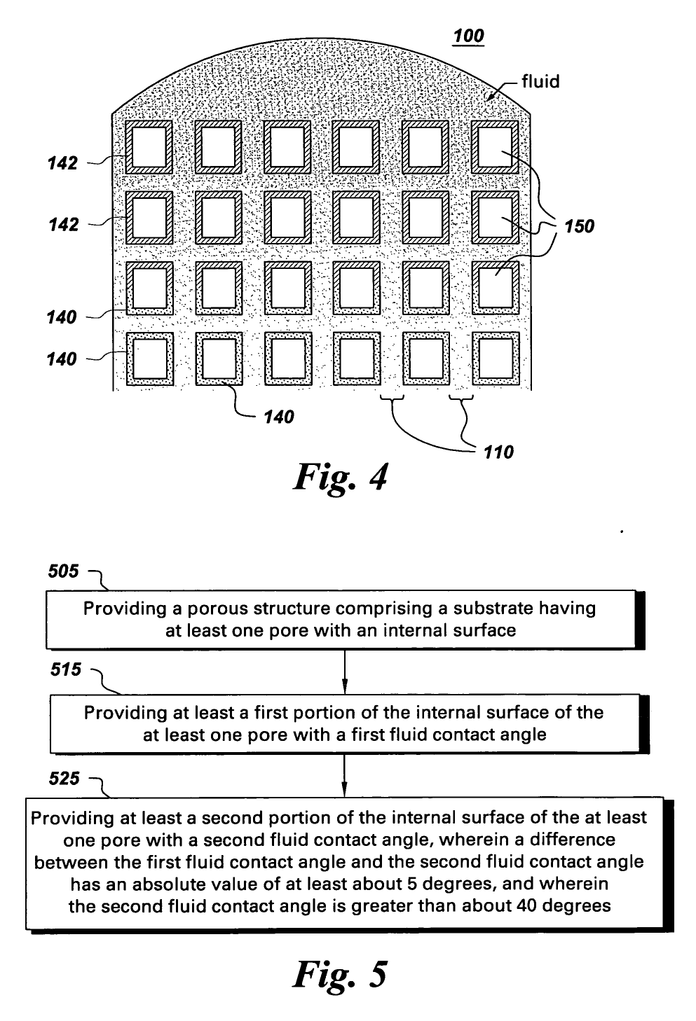

The porous structure 100 may further comprise at least a third portion (i.e. three or more) of the internal surface of a pore 110 having at least a third fluid contact angle. The third portion of the internal surface of one or more pores 110 having a third fluid contact angle may form a third region, and similarly for a fourth fluid contact angle, a fifth fluid contact angle, etc. The third fluid contact angle has an absolute value of at least 5 degrees from either the first fluid contact angle and/or second fluid contact angle. Similarly, a fourth fluid contact angle, a fifth fluid contact angle, etc., may have a difference of an absolute value of at least 5 degrees from any to all of the other fluid contact angles. In other words, the plurality of fluid contact angles can each have a difference of an absolute value of at least 5 degrees from any to all of the other fluid contact angles. FIG. 4 is a schematic representation of such a porous structure 100 with a plurality of fluid contact angles with pores 110 having internal surfaces of various wettability.

The porous structure 100 with two different fluid contact angles may be useful for various applications. Particularly, the ability to tailor the wettability of a pore's internal surface to impart, for example, hydrophobic and hydrophilic properties within a given pore and in adjacent pores in a patterned configuration may be useful in many areas such as filtration of fluid streams which contain an organic, an aqueous phase, and a particle larger than the pore size of the membrane, sensing of molecules in fluid phase, in particular biomolecules, and catalysis involving multiple catalysts, multiple phases (gas and fluid) or a combination of the above.

In reference to FIG. 5, next is described a method of making the porous structure 100. FIG. 5 is flow diagram of the method of making the porous structure 100. Referring to FIG. 5, Step 505 includes providing a porous structure comprising a substrate with at least one pore having an internal surface. In Step 515, at least a first portion of internal surface of the at least one pore with a first fluid contact angle is provided. In Step 525, at least a second portion of the internal surface of the at least one pore with a second fluid contact angle is provided.

The method is not limited by when the first 120 and second fluid contact angles 130 are provided. In one embodiment, Steps 515 and 525 of providing the first portion of the internal surface of the pore with a first fluid contact angle 120 and providing the second portion of the internal surface of the pore 110 with a second fluid contact angle 130 are simultaneously performed. In another embodiment, Steps 515 and 525 of providing the first portion of the internal surface of the pore 110 with a first fluid contact angle 120 and providing the second portion of the internal surface of the pore 110 with a second fluid contact angle 130 are sequentially performed.

The method is also not limited by how the first and second fluid contact angles are provided. In one embodiment, Step 505 of providing the porous structure 100 comprises disposing a coating on the porous structure 100. In another embodiment, a first coating 140 and a second coating 142 are disposed on the porous structure 100. In yet another embodiment, the porous structure 100 comprises a first substrate and a second substrate. Furthermore, the porous structure 100 may comprise a first coating 140 disposed on the first substrate and a second coating 142 disposed on the second substrate. As previously described herein, it should be appreciated, that in some embodiments, the internal surface of an individual pore 110 has both a first contact angle 120 and a second contact angle 130. Furthermore, it should also be appreciated, that in some embodiments, the first contact angle 120 and the second contact angle 130, respectively correspond to hydrophilic and hydrophobic internal surfaces of an individual pore 110.

In one embodiment, providing the first portion of the internal surface of the pore 110 with a first fluid contact angle 120 and providing the second portion of the internal surface of the pore 110 with a second fluid contact angle 130 comprises providing a first coating 140 to the first portion of the internal surface of pore 110. Furthermore, a plurality of first coatings 140 may be provided to the first portion of the internal surface of the pore 110. In another embodiment, a second coating 142 to the second portion of the internal surface of a pore 110 is provided. As previously stated herein above, the first coating 140 and the second coating 142 are sufficiently different to form a porous structure 100 wherein a difference between the first fluid contact angle 120 and the second fluid contact angle 130 has an absolute value of at least about 5 degrees; and wherein the second fluid contact angle is greater than about 40 degrees. Furthermore, a plurality of second coatings 142 may also be provided to the second portion of the internal surface of pore 110.

In another embodiment, providing the first portion of the internal surface of the pore 110 with a first fluid contact angle 120 and providing the second portion of the internal surface of pore 110 with a second fluid contact angle 130 comprises providing a first treatment to the first portion of the internal surface of a pore 110. Furthermore, a second treatment to the second portion of the internal surface of a pore 110 may be provided. The first treatment and the second treatment are sufficiently different to form a porous structure 100 wherein a difference between the first fluid contact angle 120 and the second fluid contact angle 130 has an absolute value of at least about 5 degrees; and wherein the second fluid contact angle is greater than about 40 degrees. Examples of treatments (first and second) include, but are not limited to, depositing an organic molecule onto the porous structure, depositing an inorganic molecule onto the porous structure, illuminating the porous structure with light, and locally heating the porous structure. Furthermore, the treatment may be administered in different ways. For example, the porous structure may be uniformly treated, such as by depositing the inorganic molecule everywhere and then selectively degrading the inorganic molecule in places not wanted. Alternatively, the porous structure may be selectively treated by depositing only in the desired regions.

The method may further comprise providing at least a third portion of (i.e. three or more) the internal surface of a pore 110 with at least a third fluid contact angle. The third portion of an internal surface with a third fluid contact angle may form a third region, and similarly for a fourth fluid contact angle, a fifth fluid contact angle, etc. The third fluid contact angle has an absolute value of at least 5 degrees from either the first fluid contact angle and/or second fluid contact angle. Similarly, the method may further comprise providing a fourth fluid contact angle, a fifth fluid contact angle, etc., having a difference of an absolute value of at least 5 degrees from any to all of the other fluid contact angles. In other words, the method may further comprise providing the plurality of fluid contact angles wherein the plurality of fluid contact angles have a difference of an absolute value of at least 5 degrees from any to all of the other fluid contact angles.

Another aspect of the invention includes a method of making a porous structure 100. The method includes providing a first porous sub-structure comprising a substrate with at least one pore 110 with an internal surface having at least a first portion of the internal surface of the at least one pore 110 has a first fluid contact angle, and providing a second porous sub-structure comprising a substrate with at least one pore 110 with an internal surface having at least a second portion of the at least one pore 110, the internal surface has a second fluid contact angle; and combining the first porous sub-structure with the second porous sub-structure to form a porous structure 100 having at least a first portion of the internal surface having a first fluid contact angle, at least a second portion of the internal surface having a second fluid contact angle 130 wherein a difference between the first fluid contact angle 120 and the second fluid contact angle 130 has an absolute value of at least about 5 degrees; and wherein the second fluid contact angle is greater than about 40 degrees.

The following examples serve to illustrate the features and advantages of the invention and are not intended to limit the invention thereto.

### EXAMPLE 1

A porous structure 100 as depicted in FIG. 1A with pores having patterned hydrophilic and hydrophobic internal surface was produced by selectively coating a porous alumina structure with a self-assembled monolayer (SAM). The porous alumina structure was immersed in a 0.01 M solution of octadecyltrichlorosilane (OTS) in toluene for 1 minute to uniformly coat the porous alumina structure with a self-assembled monolayer. The static contact angles of a droplet placed on the surface of the alumina structure before and after treatment was less than 20 and greater than 110 degrees, respectively. The coated structure was then treated by irradiating with 254 nm UV light through a patterned mask to selectively degrade the monolayer in the illuminated regions. After 1 hour, the advancing contact angle in the illuminated regions was less than 90 degrees while the advancing contact angle in the unilluminated regions was unchanged.

FIG. 2 shows the coated porous alumina structure 100 with a grid-like pattern of pores having hydrophilic and hydrophobic internal surfaces. A droplet of water containing dye placed on the porous structure wetted only the pores with hydrophilic internal surface.

Porous structures with regions having different contact angle exhibit different wetting properties. Aqueous solutions will fill pores having internal surfaces with contact angles less than about 90 degrees (hydrophilic), but are excluded from pores with contact angles above 90 degrees (hydrophobic). This effect can be measured by placing the porous structure between two aqueous electrolyte baths and measuring the electrical impedance across the structure.

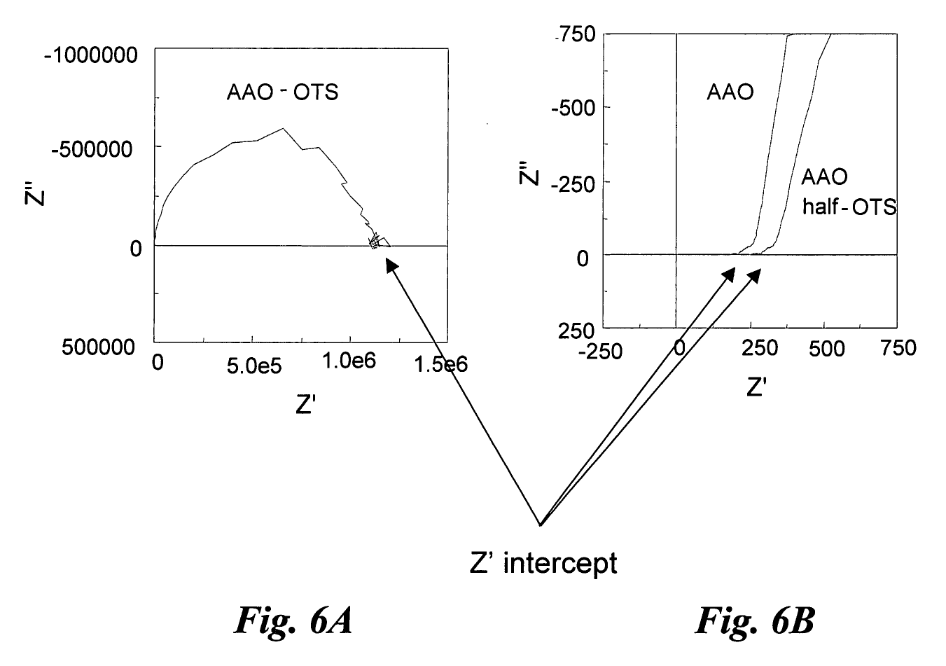

FIGS. 6A-B compare electrochemical impedance data for a porous structure 100 in accordance with an embodiment of the invention with both hydrophobic and hydrophilic regions with control samples of porous structures that are entirely hydrophobic or hydrophilic. The data shown in FIGS. 6a-6b was collected from porous alumina structures with nominally identical pore size and pore size distribution. FIG. 6a is a Nyquist plot that corresponds to a known porous structure in which all the internal surfaces of pores are hydrophobic. The resistance of the structure, as inferred from the Z′-intercept of the semicircle, is approximately 2000000 ohms. FIG. 6b shows two Nyquist plots in which one Nyquist plot corresponds to a porous structure 100 in accordance with an embodiment of the invention in which about half of the internal surfaces of the pores are hydrophobic and the remainders are hydrophilic and the other Nyquist plot corresponds to a known porous structure 100 in which all of the internal surfaces of the pores are hydrophilic. The resistances of the (i) mixed hydrophobic/hydrophilic porous structure in accordance with an embodiment of the invention and (ii) the known hydrophilic porous structure, as inferred from the Z′-intercept of the semicircles are approximately 300 and 200 ohms, respectively. The resistance of the porous structure 100 with hydrophilic and hydrophobic internal surfaces was four orders of magnitude less than the known structure with only hydrophobic internal surfaces and about 50% larger than the structure with only hydrophilic internal surfaces.

### EXAMPLE 2

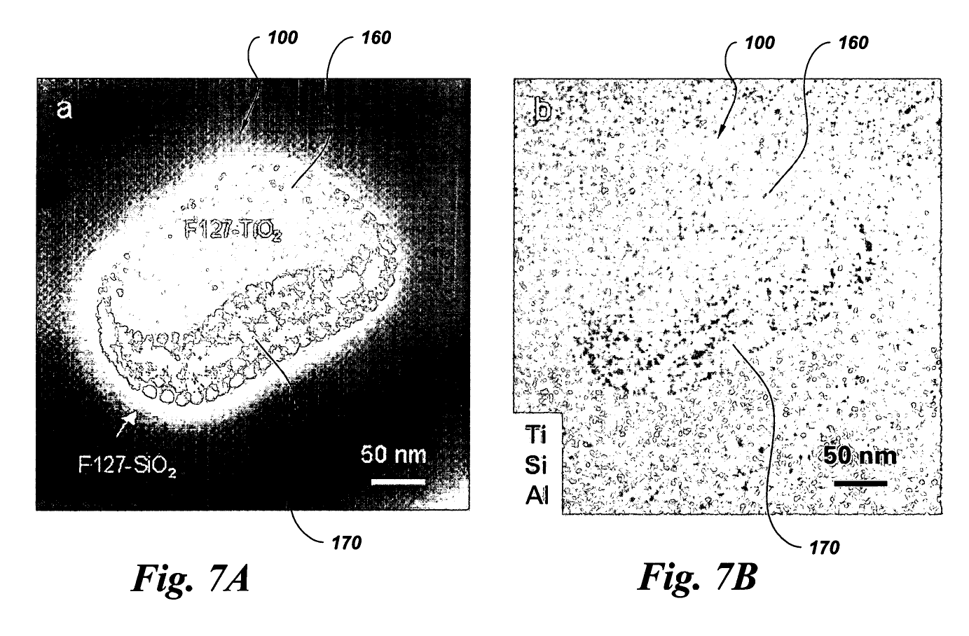

A porous structure 100 as depicted in FIG. 3 with a first region 160 and a second region 170 comprising different pore wall structures and coatings was prepared by depositing mesoporous silica and mesoporous titania into a porous alumina structure. FIGS. 7A-7B show TEM micrographs of this porous structure 100. The water contact angles of mesoporous titania and silica are about 10 degrees and 20 degrees, respectively. The pores of this porous structure 100 can be subsequently coated with an organic molecule such as a SAM to further alter the contact angles. The heterogeneity in chemical composition leads to different degrees of coating by the molecule. Furthermore, the coating 140 can be degraded at different rates on the different wall compositions to further tune the filled contact angle to the desired values. The resulting porous structure 100 can be irradiated with UV light for a short period of time to degrade the SAM on the titania without appreciably degrading the SAM on the silica.

### EXAMPLE 3

The porous structure 100 may have more than two contact angles corresponding to more than two regions. A porous structure 100 as depicted in FIG. 4 with a graded placement transition of multiple regions with hydrophobic and hydrophilic properties was produced by selectively coating a porous alumina structure with a self-assembled monolayer. The porous alumina structure was immersed in a 0.01 M solution of OTS in toluene for 10 minutes to uniformly coat the porous alumina structure with a self-assembled monolayer. The static contact angles of a droplet placed on the surface of the porous alumina structure before and after treatment was less than 20 and greater than 125 degrees, respectively. The coated porous alumina structure was then treated by irradiating with 254 nm UV light to selectively degrade the monolayer near the surface of the porous alumina structure. The extent of the monolayer degradation varies with the local UV intensity. The local UV intensity varies with depth in the porous structure due to absorption and scattering by the porous structure. Consequently, the monolayer quality will vary with depth, thereby providing a porous structure with a gradient in wettability characteristics. After 30 minutes, the static water contact angle of the side of the porous alumina structure facing the UV light source was less than 100 degrees, while the static water contact angle on the side of the porous alumina structure facing away from the UV light source was unchanged.

### EXAMPLE 4

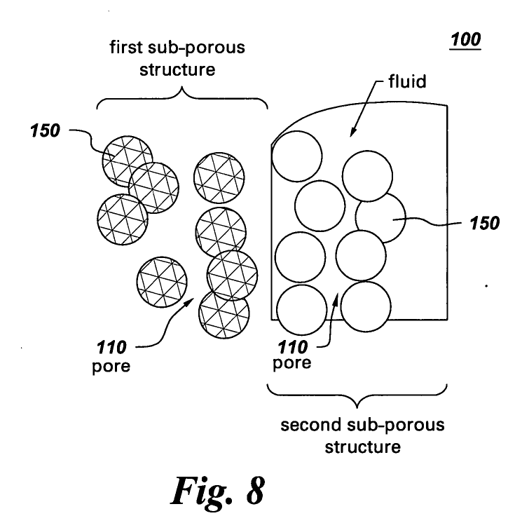

A porous structure 100 as depicted in FIG. 8 with different regions having different contact angles can be produced by the consolidation of particles of different composition.

The porous structure 100 depicted in FIG. 8 can be prepared by consolidating agglomerates of silica nanoparticles with agglomerates of gold nanoparticles. A short thermal treatment can be used to provide mechanical stability to the porous structure 100. The pores with silica walls possess a different contact angle from the pores with gold walls. Both sets of pores are hydrophilic. The resulting structure could be treated with an alkoxysilane to render the porous regions with silica walls hydrophobic. Alternately, the consolidated structure can be treated with an alkanethiol to render the porous regions with gold walls hydrophobic.

Consolidating mesoporous silica particles with hydrophobic pores and hydrophilic exteriors can produce the porous structure depicted in FIG. 8. Mesoporous silica particles with hydrophobic pores can be prepared following recipes described in the prior art. The exterior of these particles can be treated with oxygen plasma to make the exterior of these particles hydrophilic. These particles can be consolidated using traditional ceramics processing methods into a packed green body.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

What is claimed is:

1. A porous structure comprising:
a substrate comprising at least one pore having an internal surface,
wherein at least a first portion of the internal surface of the at least one pore has a first fluid contact angle;
wherein at least second portion of the internal surface of the at least one pore has a second fluid contact angle; and
wherein a difference between the first fluid contact angle and the second fluid contact angle has an absolute value of at least about 5 degrees; and wherein the second fluid contact angle is greater than about 40 degrees.

2. The porous structure of claim 1, wherein the first fluid contact angle is in a range from about 0 to about 90 degrees and the second fluid contact angle is in a range from about 90 degrees to about 180 degrees.

3. The porous structure of claim 1, wherein the at least one pore comprises a plurality of pores.

4. The porous structure of claim 3, wherein each pore has a pore size in a range from about 1 nm to about 2 um.

5. The porous structure of claim 4, wherein each pore size is in a range from about 15 nm to about 300 nm.

6. The porous structure of claim 3, wherein the plurality of pores comprises at least some pores that are interconnected.

7. The porous structure of claim 3, wherein the plurality of pores comprise at least some pores that are not interconnected.

8. The porous structure of claim 1, wherein the porous structure comprises a material selected from a group consisting of a ceramic material, polymer, metal, and combinations thereof.

9. The porous structure of claim 7, wherein the material comprises a ceramic material.

10. The porous structure of claim 8, wherein the ceramic material comprises a ceramic material selected from a group consisting of an oxide, a borate, an aluminate, a silicate, a phosphate, a nitride, a boride, a carbide and combinations thereof.

11. The porous structure of claim 6, wherein the material comprises a polymer.

12. The porous structure of claim 1, wherein a coating is disposed on the substrate.

13. The porous structure of claim 12, wherein the coating comprises a multilayer coating.

14. The porous structure of claim 12, wherein the coating comprises an organic or inorganic molecule.

15. The porous structure of claim 14, wherein the organic or inorganic molecule comprises at least one adsorbed layer of molecules selected from a group consisting of self-assembling monolayers, alcohols, ketones, amines, carboxylic acids, esters, amides, olefins, parrafins, acetylenes, halides, aromatics, thiols, sulfonates, metal organics, organometallics, amino acids, proteins, fatty acids, peptides, and organic natural products.

16. The porous structure of claim 15, wherein the self-assembling monolayer comprises a member selected from a group consisting of alkylchlorosilanes, alkoxysilanes, mercaptosilanes, thiols, and self assembling monolayers comprising or formed from:
CH₃(CH₂)ₙX
wherein n is an integer in a range from about 1 to about 20;
and X is selected from a group consisting of alkylchlorosilanes, alkoxysilanes, mercaptosilanes, and thiols.

17. The porous structure of claim 1, wherein the at least a first portion of the internal surface having a first fluid contact angle forms a first region and wherein the at least a second portion of the internal surface having a second fluid contact angle forms a second region.

18. The porous structure of claim 17, wherein the first region and the second region are adjacent to each other.

19. The porous structure of claim 17, wherein the first region comprises a plurality of pores.

20. The porous structure of claim 17, wherein the second region comprises a plurality of pores.

21. The porous structure of claim 17, wherein the first region and the second region are disposed in a pattern.

22. The porous structure of claim 1, further comprising at least a third portion of the internal surface of the at least one pore having at least a third fluid contact angle.

23. The porous structure of claim 22, wherein the at least a third portion of an internal surface having at least a third fluid contact angle forms at least a third region.

24. The porous structure of claim 23, wherein the at least a third fluid contact angle has an absolute value of at least 5 degrees from the first fluid contact angle or second fluid contact angle.

25. A method of making a porous structure comprising:
(i) providing a porous structure comprising a substrate having at least one pore with an internal surface;
(ii) providing at least a first portion of the internal surface of the at least one pore with a first fluid contact angle;
(iii) providing at least a second portion of the internal surface of the at least one pore with a second fluid contact angle;
wherein a difference between the first fluid contact angle and the second fluid contact angle has an absolute value of at least about 5 degrees; and
wherein the second fluid contact angle is greater than about 40 degrees.

26. The method of claim 25, wherein the providing the at least a first portion of the internal surface with a first fluid contact angle and providing the at least a second portion of the internal surface with a second fluid contact angle are simultaneously performed.

27. The method of claim 25, wherein the providing the at least a first portion of the internal surface with a first fluid contact angle and providing the at least a second portion of the internal surface with a second fluid contact angle are sequentially performed.

28. The method of claim 25, wherein the first fluid contact angle is in a range from about 0 to about 90 degrees and the second fluid contact angle is in a range from about 90 degrees to about 180 degrees, and wherein the first contact angle is provided first.

29. The method of claim 25, wherein providing the substrate comprises providing a coating disposed on the substrate.

30. The method of claim 29, wherein the coating comprises a first coating and a second coating.

31. The method of claim 29, wherein the porous structure further comprises a second substrate.

32. The method of claim 31, wherein the second substrate comprises a second coating disposed on the substrate.

33. The method of claim 25, wherein providing the at least a first portion of the internal surface with a first fluid contact angle and providing the at least a second portion of the internal surface with a second fluid contact angle comprises providing a first coating to the at least a first portion of the internal surface of the at least one pore.

34. The method of claim 33, further providing a plurality of coatings to the at least a first portion of the internal surface.

35. The method of claim 33, further providing a second coating to the at least second portion of the internal surface.

36. The method of claim 35, further providing a plurality of coatings to the at least second portion of the internal surface.

37. The method of claim 25, wherein providing the at least a first portion of the internal surface with a first fluid contact angle and providing the at least a second portion of the internal surface with a second fluid contact angle comprises providing a first treatment to the at least a first portion of the internal surface.

38. The method of claim 37, wherein the first treatment comprises a treatment selected from a group consisting of depositing an organic molecule onto the porous structure, depositing an inorganic molecule onto the porous structure, illuminating the porous structure with light, and locally heating the porous structure.

39. The method of claim 37, further providing a second treatment to the at least second portion of the internal surface of the at least one pore.

40. The method of claim 25, wherein the at least a first portion of the internal surface with a first fluid contact angle forms a first region and wherein the at least a second portion of the internal surface with a second fluid contact angle forms a second region.

41. The method of claim 25, further comprising providing at least a third portion of the internal surface of the at least one pore with at least a third fluid contact angle, wherein the at least a third fluid contact angle has an absolute value of at least 5 degrees from the first fluid contact angle or second fluid contact angle.

42. A method of making a porous structure comprising:
i) providing a first porous sub-structure comprising a substrate having at least one pore with an internal surface, wherein at least a first portion of the internal surface of the at least one pore has a first fluid contact angle; and providing a second porous sub-structure comprising a substrate having at least one pore with an internal surface, wherein at least a second portion of the at least one pore of the internal surface has a second fluid contact angle; and
ii) combining the first porous sub-structure with the second porous sub-structure to form a porous structure comprising at least a first portion of the internal surface having a first fluid contact angle; at least a second portion of the internal surface having a second fluid contact angle; and wherein a difference between the first fluid contact angle and the second fluid contact angle has an absolute value of at least about 5 degrees; and wherein the second fluid contact angle is greater than about 40 degrees.

43. The method of claim 42, further providing at least a third porous sub-structure to the porous structure, wherein the third porous sub-structure comprises a substrate having at least one pore with an internal surface, wherein at least a third portion of the internal surface has a third fluid contact angle to form a porous structure with a first fluid contact angle, a second fluid contact angle, and at least a third contact angle, wherein the at least a third fluid contact angle has an absolute value of at least 5 degrees from the first fluid contact angle or second fluid contact angle.
